(19) United States
(12) Patent Application Publication
(10) Pub. No.: US 2009/0079197 A1
(43) Pub. Date: Mar. 26, 2009

(54) EXPANDABLE APPARATUS FOR GENERATING ELECTRIC POWER USING WIND ENERGY

(76) Inventor: Hao-Wei Poo, Taipei City (TW)

Correspondence Address: LADAS & PARRY LLP, 224 SOUTH MICHIGAN AVENUE, SUITE 1600, CHICAGO, IL, 60604, US

(21) Appl. No.: 11/861,419

(22) Filed: Sep. 26, 2007

(51) Int. Cl. F03D 9/00

(52) U.S. Cl. 290/55

(57) ABSTRACT

An electric generating unit includes an upright rod unit extending vertically along a pivot axis and having a lower end fixed to a structural frame, a blade unit mounted rotatably on the upright rod unit and rotatable relative to the structural frame about the upright rod unit so as to convert wind energy into a mechanical rotary power output, and a generator disposed in the structural frame and coupled to the blade unit to convert the mechanical rotary power output into electric power. The upright rod unit includes rods aligned along the pivot axis and connected detachably to each other. The blade unit includes blade members arranged in an axial direction of the upright rod unit, connected detachably to each other, and mounted rotatably and respectively on the rods of the upright rod unit.

### BACKGROUND OF THE INVENTION

1. Field of the Invention

The invention relates to an expandable apparatus for generating electric power from wind energy.

2. Description of the Related Art

Referring to FIG. 1, a conventional apparatus 10 for generating electric power from wind energy is shown to include a rotary turbine unit 15 coupled to a shaft 16 of a generator 17 and converting wind energy into a mechanical rotary power output. The generator 17 converts the mechanical rotary power output into electric power.

Referring to FIGS. 2 and 3, another conventional apparatus 1 for generating electric power from wind energy is shown to include an upright structural frame 11, a first blade unit 12 mounted rotatably in an upper portion of the structural frame 11, a second blade unit 13 mounted rotatably in a lower portion of the structural frame 11, and a generator 14 mounted in the structural frame 1, and disposed between and coupled to the first and second blade units 12, 13.

The first blade unit 12 includes a first pivot rod 121 having an upper end connected pivotally to the top of the structural frame 11, and a lower end coupled to a magnet ring 141 of the generator 14, two circular first plates 122, 123 mounted on the first pivot rod 121 and spaced apart from each other, and opposite curved first blades 124 interconnected between the first plates 122, 123 and extending clockwise and outwardly from the first pivot rod 121.

The second blade unit 13 includes a second pivot rod 131 having a lower end connected pivotally to the bottom of the structural frame 11 and coupled to a winding unit 142 of the generator 14, two circular second plates 132, 133 mounted on the second pivot rod 131 and spaced apart from each other, and opposite curved second blades 134 interconnected between the second plates 132, 133 and extending counterclockwise and outwardly from the second pivot rod 131.

The first and second blade units 12, 13 are rotatable in opposite directions, respectively, such that each of the first and second blade units 12, 13 converts wind energy into a mechanical rotary power output.

The generator 14 converts the mechanical rotary power outputs from the first and second blade units 12, 13 into electric power.

However, in the conventional apparatuses 10 and 1, the number of the rotary turbine unit 15 and the blade units 12, 13 applied to the generator 17, 14 is fixed and cannot be increased.

### SUMMARY OF THE INVENTION

Therefore, the object of the present invention is to provide an apparatus for generating electric power from wind energy that can overcome the aforesaid drawback of the prior art.

According to the present invention, there is provided an apparatus for generating electric power from wind energy. The apparatus comprises:

an upright structural frame having a base frame portion; and

an electric generating unit including
an upright rod unit extending vertically along a pivot axis and having a lower end connected to the base frame portion of the structural frame, and an upper end,
a blade unit mounted rotatably on the upright rod unit and rotatable relative to the structural frame about the upright rod unit so as to convert wind energy into a mechanical rotary power output, and
a generator mounted on the base frame portion of the structural frame and coupled to the blade unit to convert the mechanical rotary power output into electric power.

The upright rod unit includes a plurality of rods aligned along the pivot axis and connected detachably to each other. Each of the rods has opposite upper and lower ends. The upper end of an uppermost one of the rods serves as the upper end of the upright rod unit. The lower end of a lowermost one of the rods serves as the lower end of the upright rod unit.

The blade unit includes a plurality of blade members arranged in an axial direction of the upright rod unit, connected detachably to each other, and mounted rotatably and respectively on the rods of the upright rod unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional apparatus for generating electric power from wind energy;

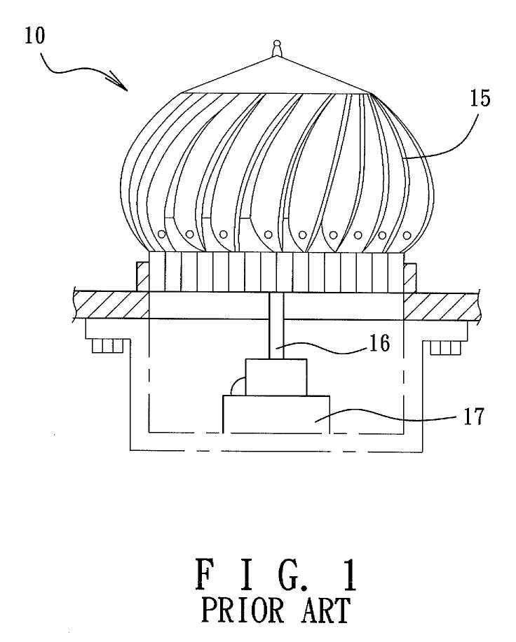

FIG. 2 is a perspective view of another conventional apparatus for generating electric power from wind energy;

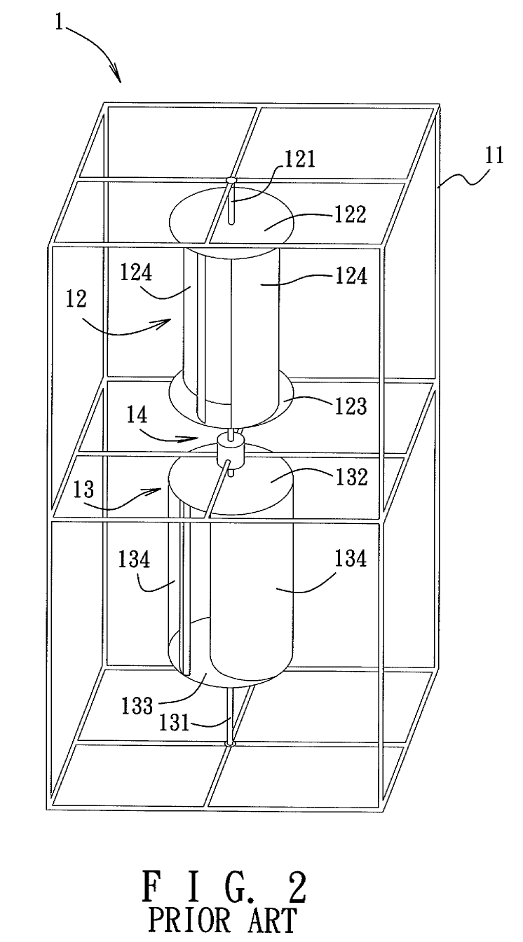

FIG. 3 is a schematic partly sectional view of a generator of the conventional apparatus of FIG. 2;

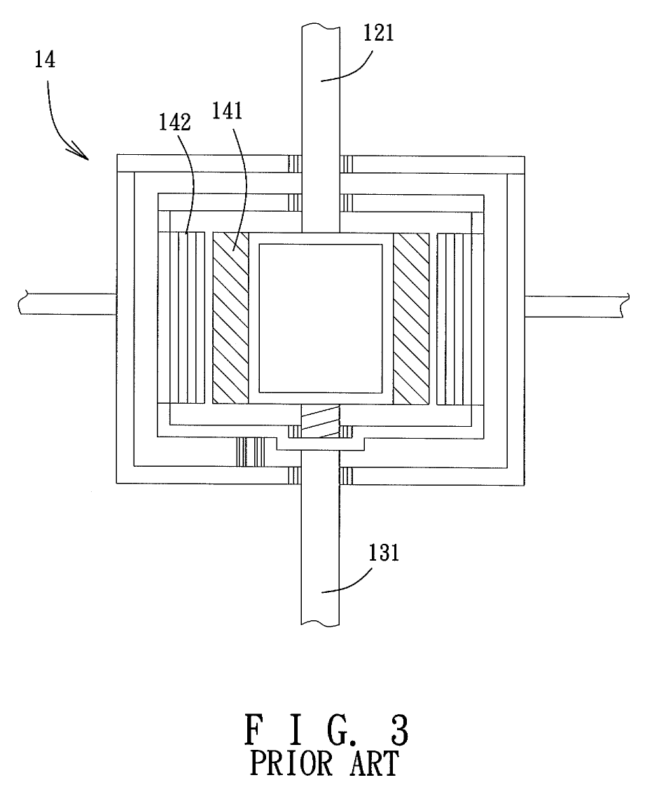

FIG. 4 is a perspective view showing the first preferred embodiment of an apparatus for generating electric power from wind energy according to the present invention;

FIG. 5 is a partly exploded perspective view showing a blade member of a blade unit and a corresponding rod of an upright rod unit of the first preferred embodiment;

FIG. 6 is a partly exploded perspective view showing the upright rod unit and the blade unit of the first preferred embodiment;

FIG. 7 is an exploded perspective view showing a sleeve and two looped bearings of the first preferred embodiment;

FIG. 8 is an exploded fragmentary perspective view showing two adjacent sleeves and a washer of the first preferred embodiment; and

FIG. 9 is a perspective view showing the second preferred embodiment of an apparatus for generating electric power from wind energy according to the present invention.

### DETAILED DESCRIPTION OF THE PREFERRED EMBODIMENTS

Before the present invention is described in greater detail, it should be noted that like elements are denoted by the same reference numerals throughout the disclosure.

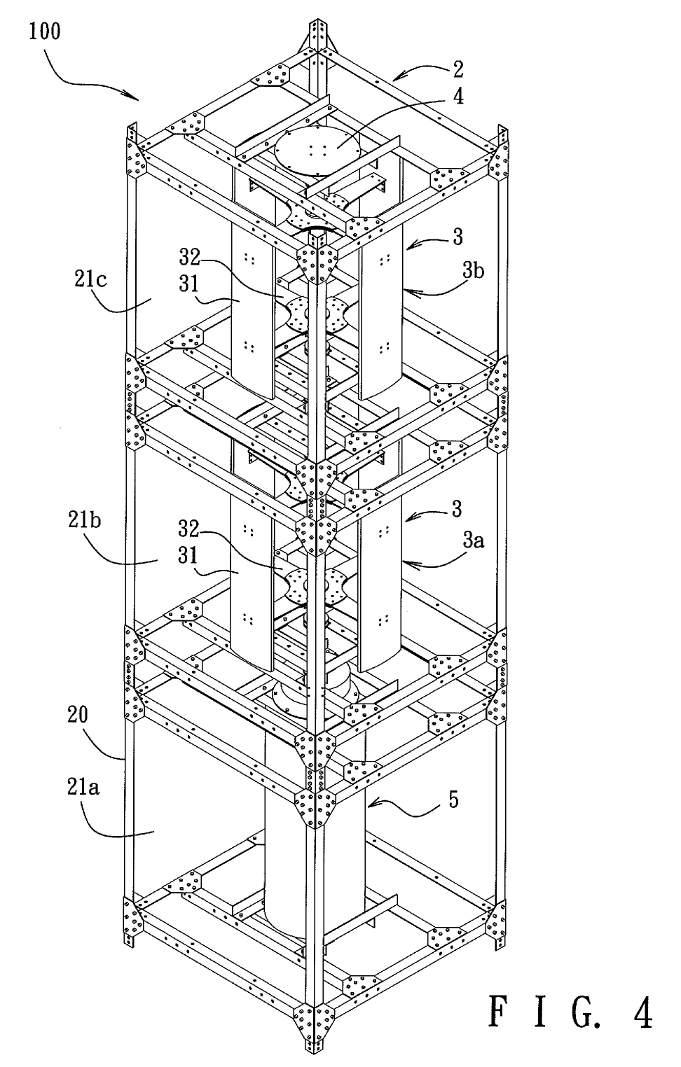

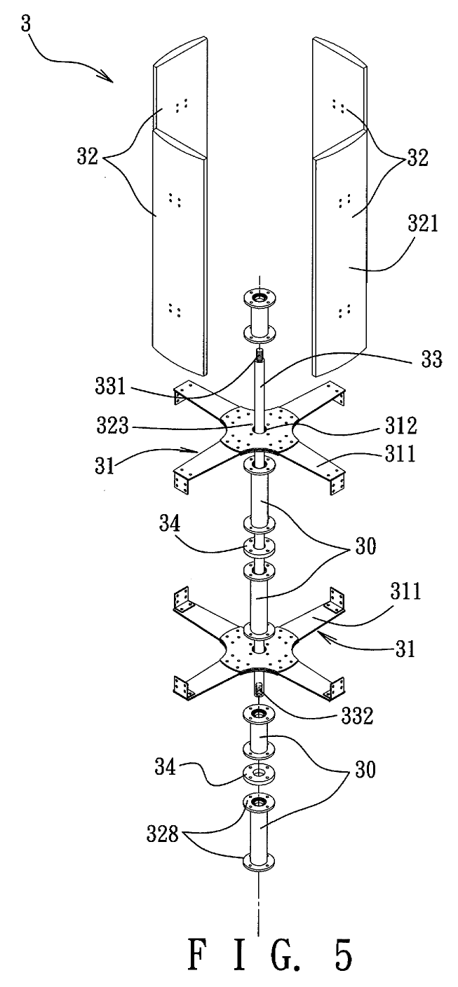

Referring to FIGS. 4 to 6, the first preferred embodiment of an apparatus 100 for generating electric power from wind energy according to the present invention is shown to include an upright structural frame 2 and an electric generating unit.

The structural frame 2 has a base frame portion 20 configured with a first receiving space (21a). In this embodiment, the structural frame 2 is further configured with second and third receiving spaces (21b, 21c) disposed above the first receiving space (21a).

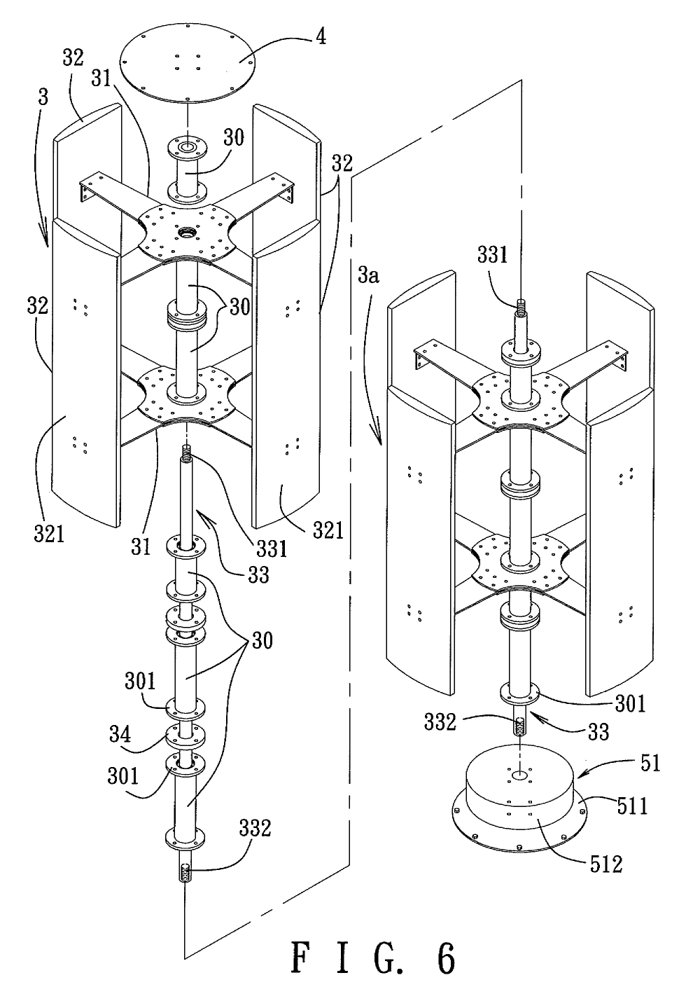

The electric generating unit includes an upright rod unit, a blade unit and a generator unit 5. The upright rod unit extends vertically along a pivot axis, and has a lower end connected to the base frame portion 20 of the structural frame 2, and an upper end. In this embodiment, the upright rod unit includes two rods 33 aligned along the pivot axis, connected detachably to each other, and disposed respectively in the second and third receiving spaces (21b, 21c) in the structural frame 2. Each rod 33 has opposite upper and lower ends 331, 332. The upper end 331 of an uppermost one of the rods 33 serves as the upper end of the upright rod unit. The lower end 332 of a lowermost one of the rods 33 serves as the lower end of the upright rod unit. The upper end 331 of each rod 33 has an externally threaded portion, and the lower end 332 of each rod 33 has an internally threaded portion, as shown in FIG. 6.

The blade unit is mounted rotatably on the upright rod unit such that the blade unit is rotatable relative to the structural frame 2 about the upright rod unit for converting wind energy into a mechanical rotary power output. In this embodiment, the blade unit includes two blade members 3 arranged in an axial direction of the upright rod unit, connected detachably to each other, and mounted rotatably and respectively on the rods 33 of the upright rod unit. Each blade member 3 includes two cross-shaped blade-mounting seats 31, four upright blades 32, and a set of sleeves 30. Details of each blade member 3 are described as follows.

The blade-mounting seats 31 are sleeved rotatably on a corresponding one of the rods 33 of the upright rod unit, and are spaced apart from each other. Each blade mounting seat 31 has a central portion formed with a through hole 312 to permit extension of the corresponding one of the rods 33 of the upright rod unit therethrough, and four connecting arms 311 extending from the central portion and spaced apart from each in a circumferential direction of the upright rod unit.

Each upright blade 32 is mounted on corresponding connecting arms 311 of an assembly of the blade-mounting seats 31. In this embodiment, each upright blade 32 has an outer convex surface facing the wind, as shown in FIG. 6.

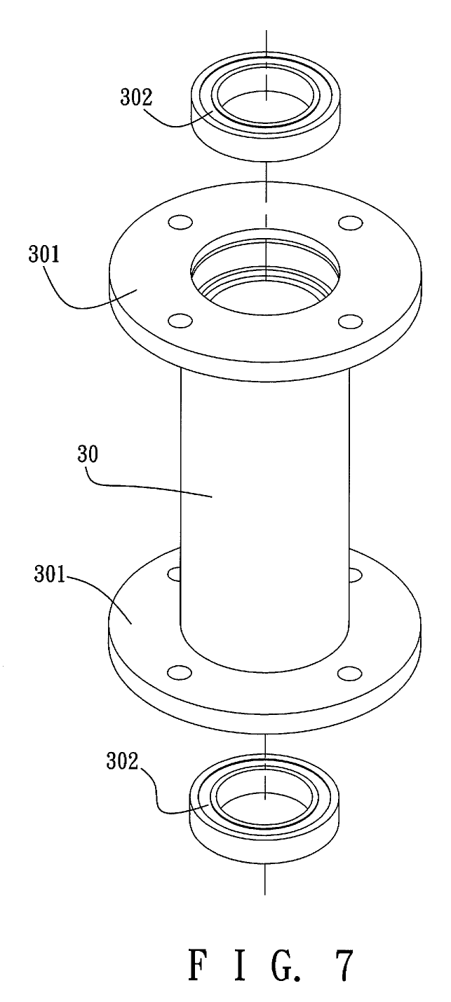

The sleeves 30 are sleeved rotatably on the corresponding one of the rods 33 of the upright rod unit, and are connected fixedly to the blade-mounting seats 31. Each sleeve 30 has opposite ends, each of which is formed with an annular connecting flange 301 extending radially and outwardly, and is provided with looped bearings 302 therein sleeved on the corresponding one of the rods 33 of the upright rod unit and disposed respectively adjacent to the opposite ends, as shown in FIG. 7. In this embodiment, a lower one of the annular connecting flanges 301 of an uppermost one of the sleeves 30 is connected fixedly to the central portion of an upper one of the blade-mounting seats 31 by a plurality of screw fasteners (not shown). Two middle ones of the sleeves 30 are connected fixedly to each other by interconnecting fixedly two adjacent ones of the annular connecting flanges 301 using a plurality of bolts and nuts, and an assembly of the two middle ones of the sleeves 30 interconnects the central portions of the blade-mounting seats 31. At least two lower ones of the sleeves 30 are connected fixedly to each other in the same manner as described above, and an assembly of at least two lower ones of the sleeves 30 is connected fixedly to the central portion of a lower one of the blade-mounting seats 31.

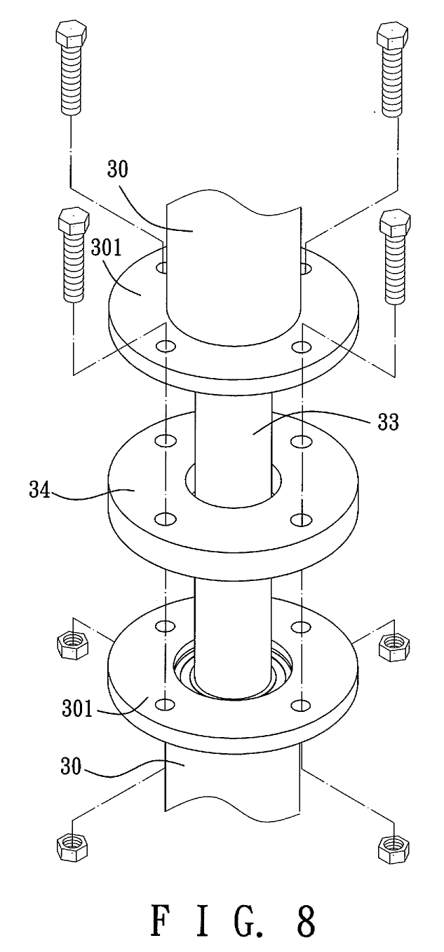

It is noted that each blade member 3 further includes a plurality of rubber washers 34 each sandwiched between a corresponding adjacent pair of the annular connecting flanges 301 of the sleeves 30, as shown in FIG. 8.

The generator unit 5 is disposed in the first receiving space (21a) in the base frame portion 20 of the structural frame 2, and includes a generator 51 mounted on the base frame portion 20 and coupled to the blade unit to convert the mechanical rotary power output into electric power. In this embodiment, the generator 51 has a generator seat 511 mounted on the base frame portion 20 and connected to the lower end of the upright rod unit, and a rotary member 512 disposed rotatably on the generator seat 511 and connected fixedly to the blade unit, i.e., the lower annular connecting flange 301 of a lowermost one of the sleeves 30 of the lower blade member 3, as shown in FIG. 6. Since the feature of the invention does not reside in the configuration of the generator 51, which is conventional, details of the same are omitted herein for the sake of brevity.

The electric generating unit further includes a cover 4 connected to the upper end of the upright rod unit for covering the uppermost sleeve 30 of the upper blade member 3 of the blade unit. In this embodiment, the cover 4 is further fixed on the top of the structural frame 2.

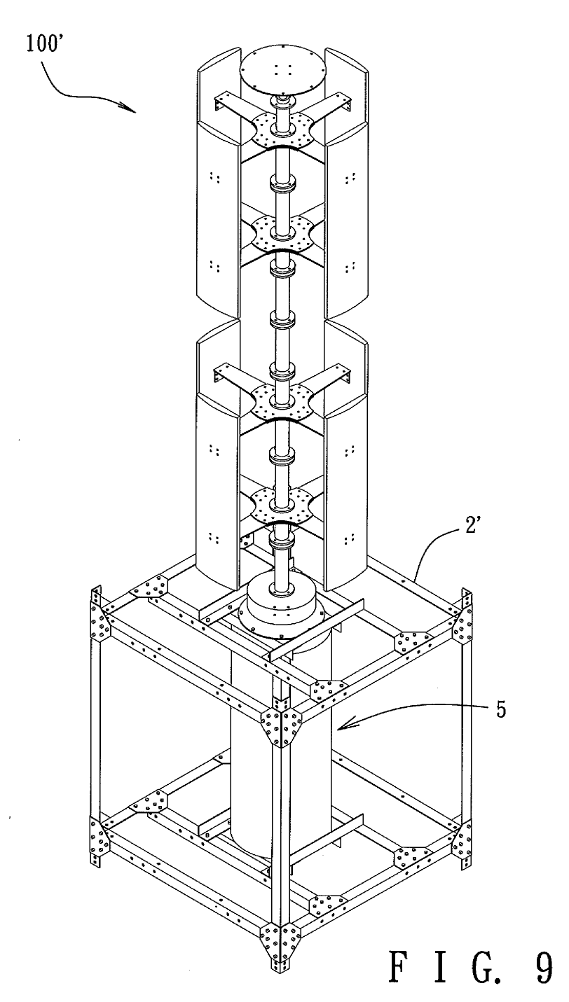

FIG. 9 illustrates the second preferred embodiment of an apparatus 100′ for generating electric power from wind energy according to this invention, which is a modification of the first preferred embodiment. Unlike the previous embodiment, the structural frame 2′ is merely used for mounting the generator 5 therein. That is, the upright rod unit and the blade unit are disposed outside the structural frame 2′.

In sum, the number of the rods 33 of the upright rod unit, and the number of the blade members 3 of the blade unit can be changed as desired. Therefore, the apparatus 100, 100′ of this invention has expansibility.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An apparatus for generating electric power from wind energy, comprising:
an upright structural frame having a base frame portion; and
an electric generating unit including
an upright rod unit extending vertically along a pivot axis and having a lower end connected to said base frame portion of said structural frame, and an upper end,
a blade unit mounted rotatably on said upright rod unit and rotatable relative to said structural frame about said upright rod unit so as to convert wind energy into a mechanical rotary power output, and
a generator mounted on said base frame portion of said structural frame and coupled to said blade unit to convert the mechanical rotary power output into electric power;
wherein said upright rod unit includes a plurality of rods aligned along the pivot axis and connected detachably to each other, each of said rods having opposite upper and lower ends, said upper end of an uppermost one of said rods serving as said upper end of said upright rod unit, said lower end of a lowermost one of said rods serving as said lower end of said upright rod unit; and
wherein said blade unit includes a plurality of blade members arranged in an axial direction of said upright rod unit, connected detachably to each other, and mounted rotatably and respectively on said rods of said upright rod unit.

2. The apparatus as claimed in claim 1, wherein one of said upper and lower ends of each of said rods has an externally threaded portion, and the other one of said upper and lower ends of each of said rods has an internally threaded portion engagable with said externally threaded portion of an adjacent one of said rods.

3. The apparatus as claimed in claim 2, wherein each of said blade members of said blade unit includes:
a plurality of blade-mounting seats sleeved rotatably on a corresponding one of said rods of said upright rod unit and spaced apart from each other;
a plurality of upright blades mounted on an assembly of said blade-mounting seats; and
a set of sleeves sleeved rotatably on the corresponding one of said rods of said upright rod unit and connected fixedly to said blade-mounting seats.

4. The apparatus as claimed in claim 3, wherein each of said sleeves of each of said blade members has opposite ends, each of which is formed with an annular connecting flange extending radially and outwardly, two adjacent ones of said annular connecting flanges of any two adjacent ones of said sleeves being interconnected fixedly.

5. The apparatus as claimed in claim 4, wherein each of said blade members further includes a plurality of rubber washers each sandwiched between a corresponding adjacent pair of said annular connecting flanges of said sleeves.

6. The apparatus as claimed in claim 4, wherein each of said sleeves is provided with two looped bearings therein sleeved on the corresponding one of said rods of said upright rod unit and disposed respectively adjacent to and covering said opposite ends thereof.

7. The apparatus as claimed in claim 1, wherein said electric generating unit further includes a cover connected to said upper end of said upright rod unit.
